(19) United States
(12) Patent Application Publication
(10) Pub. No.: US 2007/0235561 A1
(43) Pub. Date: Oct. 11, 2007

(54) TEE VALVE

(76) Inventor: Patricia Nausid, Ketchikan, AK (US)

Correspondence Address: BLACK LOWE & GRAHAM, PLLC, 701 FIFTH AVENUE, SUITE 4800, SEATTLE, WA, 98104, US

(21) Appl. No.: 11/733,450

(22) Filed: Apr. 10, 2007

Related U.S. Application Data
(60) Provisional application No. 60/790,651, filed on Apr. 10, 2006.

(51) Int. Cl. B05B 7/26; B05B 15/06; B05B 7/12

(52) U.S. Cl. 239/310; 239/201; 239/407

(57) ABSTRACT

A tee valve includes a primary conduit configured to be connected to a water flow conduit. It includes an outflow tube that collects a portion of the water flow and directs it toward a fertilizer feeder along a secondary water flow path. An inflow tube connects to the primary conduit downstream from the outflow pipe to return the secondary water flow to the primary water flow path, with the secondary water flow return water now including a concentration of fertilizer or other water additive. In this fashion, any irrigation system can be used as a combination fertilizer delivery system.

### PRIORITY CLAIM

This application claims the benefit of U.S. Provisional application Ser. No. 60/790,651 filed Apr. 10, 2006.

### FIELD OF THE INVENTION

This invention relates generally to pipes and valves, particularly for use with irrigation systems.

### BACKGROUND OF THE INVENTION

There are a wide variety of irrigation systems for delivering water to fields and other agricultural areas. In many cases, these agricultural areas require fertilization as well. The fertilization is typically introduced using a delivery means other than by the irrigation system, and such delivery systems can be expensive and inefficient.

There is therefore a need for an improved method for delivering fertilizer or other products to agricultural areas through the use of existing water delivery pipes, hoses, or similar systems.

### SUMMARY OF THE INVENTION

The invention comprises a valve that can be used in conjunction with water delivery systems. The term “valve” is used here because in some examples of the invention the water flow through the valve can be manually or automatically controlled in addition to directing a portion of the water flow away from a primary flow path and toward a fertilizer feed path. In some examples of the invention, however, there is no adjustable control and the water flow always follows the same general path.

In a primary form, the tee valve includes a primary pipe configured to be connected to a water flow pipe (or hose or other fluid conduit). The valve includes an outflow tube that collects a portion of the water flow and directs it toward a fertilizer feeder along a secondary water flow path. An inflow tube connects to the primary pipe downstream from the outflow pipe to return the secondary water flow to the primary water flow path, with the secondary water flow return water including a concentration of fertilizer or other water additive. In this fashion, any irrigation system can be used as a combination fertilizer delivery system.

In accordance with varying examples of the invention, the valve may be incorporated into fixed irrigation systems or may be adjustably used with traditional residential hoses or similar water conduits.

### BRIEF DESCRIPTION OF THE DRAWINGS

Preferred and alternative embodiments of the present invention are described in detail below with reference to the following drawings:

FIG. 1 is a perspective view of a preferred tee valve;

FIG. 2 is a representative view of a preferred tee valve incorporated into an underground sprinkler system;

FIG. 3 is a perspective view of a preferred tee valve incorporated into a feeder canister;

FIG. 4 is a side elevational view of a tee valve directly coupled to a feeder canister; and

FIG. 5 is a side elevational view of a tee valve having a flow deflector located within the tee valve.

### DETAILED DESCRIPTION OF THE PREFERRED EMBODIMENT

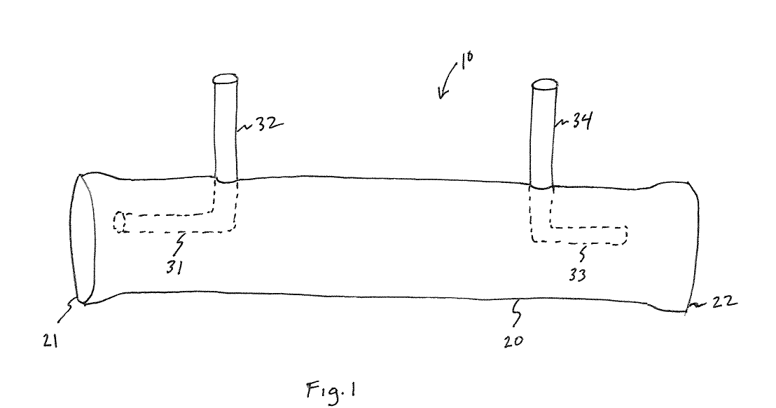

FIG. 1 depicts a preferred form of the tee valve. As shown, the valve includes a primary water conduit 20 having a first end 21 for receiving water flow and a second end 22 through which water exits. In some examples of the invention, the tee valve is generally symmetrical, such that either end may be used for the water entry or exit end.

Depending on the nature of the conduit with which the valve is to be used, the primary water conduit may be in the form to mate with a residential water hose (and therefore have threaded ends that are, for example, ½ inch, ⅝ inch, or ¾ inch), or may be formed from PVC, copper, stainless steel, or other materials so that it can mate with other irrigation systems.

A first end 21 of the primary water conduit includes threads or a flared or enlarged diameter as appropriate to mate with an irrigation conduit. In some forms, the primary water conduit can simply have a uniform diameter along its length, with no threads or other connecting configuration at either end. A second end 22 of the primary water conduit (that is, the end through which the water flow is expected to exit) likewise may be threaded, flared, or substantially uniform as desired.

Traveling in a direction from the first end toward the second end, in the direction of water flow, an outflow tube 31 extends within the interior of the primary water conduit. In the example shown, the outflow tube extends substantially parallel to the primary water conduit and is contained within the conduit. It may be configured such that it is axially at the center of the tube, or may be somewhat radially outward from the center, as with the example shown. Though characterized as an outflow “tube,” the tube need not necessarily be circular in cross section. In any event, the outflow tube is configured to collect a portion of the water flow traveling through the primary water conduit. Accordingly, the outflow tube includes an opening facing toward the expected oncoming water flow (that is, toward the first end of the primary water conduit).

The outflow tube is connected to or integrally formed with a first extension tube 32 that extends away from the primary water conduit. Thus, water is collected by the outflow tube and travels through the outflow tube and into the first extension tube. Preferably, the first extension tube has a diameter that is equal to that of the outflow tube.

Downstream from the outflow tube 31 is an inflow tube 33 and second extension tube 34. The second extension tube is preferably the same as the primary extension tube in construction, both in length and size. Likewise, it is preferably attached to the primary water flow tube at a location equidistant from the exit orifice of the primary tube as the first extension tube is with respect to the entry orifice.

The second extension tube 34 is connected to or integrally formed with a water inflow tube 33 that extends into the primary water conduit downstream from the outflow tube to return the secondary water flow to the primary water flow path, with the secondary water flow return water including a concentration of fertilizer or other water additive. The inflow tube includes an exit orifice that preferably faces in the direction of water flow such that the inflow tube is generally parallel with the outflow tube. In alternate forms, however, the two tubes may be offset or face slightly different directions so long as the outflow tube is able to collect a portion of the primary water flow and the inflow tube is able to return it.

The outflow tube extends substantially parallel to the primary water conduit and is contained within the conduit. It may be configured such that it is axially at the center of the tube, or may be somewhat radially outward from the center, as with the example shown.

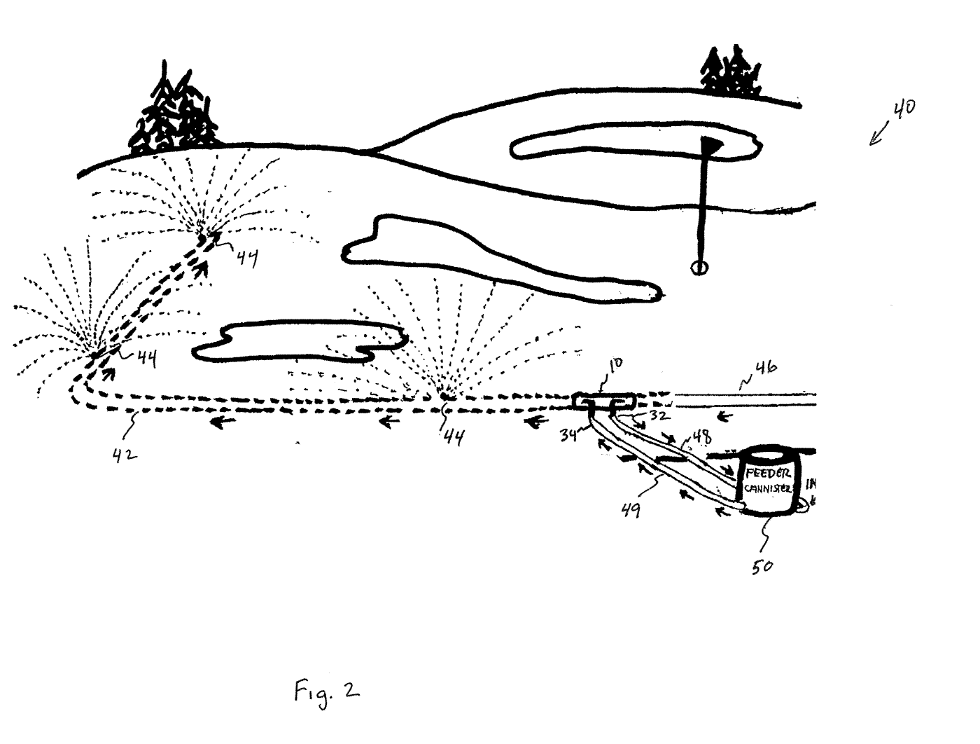

As shown in FIG. 2, the tee valve may be incorporated into a fixed irrigation system 40. Thus, the irrigation system may comprise a system of underground pipes 42 and sprinklers 44, with the pipes and sprinklers connected to a primary water supply conduit 46. By placing the tee valve 10 within the primary water supply conduit, the water intended to travel to each of the sprinklers will first travel through the tee valve. In this fashion, the tee valve may be installed into such a system originally or may be added to a system already in place.

As shown, the first extension tube 32 is attached to a tube or hose 48 that directs water flow to a feeder canister 50. Another tube or hose 49 directs water flow from the feeder canister and back to the second extension tube 34. The feeder canister preferably includes fertilizer, which may be in either liquid or powder form. Most preferably, the fertilizer is a concentrated liquid.

As water travels through the main water conduit of the tee valve, a portion of the water is redirected through the outflow tube and into the first extension tube. This secondary flow continues through the hose until it reaches the feeder canister, where it mixes with the concentrated fertilizer. The water—now containing fertilizer—returns through a hose to the second extension tube and into the inflow tube to enable the fertilizer water to mix with the main water supply. The water flow path carries this fertilized water to the sprinklers which then spray the fertilized water onto the plants as desired.

In the preferred form, the feeder canister contains liquid fertilizer, but it may alternatively contain any pesticide, chemical, treatment, or other ingredient that might be used in agriculture. Likewise, the feeder canister may be directly attached to the tee valve, without the necessity of additional hoses or tubes extending between the valve and the canister. In some configurations the extra tubes or hoses may be desirable, in order to ensure that the feeder canister can be located at a safe and proper location. For example, the feeder canister may be buried in an underground location (such as beneath an access panel) or within a service shed or other structure to monitor its contents and ensure safety.

Although not illustrated, the tee valve may also include a true valve control to manually or automatically control the delivery of fertilizer or other materials. In one form, an open/shut control valve is placed in the flow path of the first extension tube in order to selectively enable or block the flow of water through the first extension tube. Such control valves are readily available for use in irrigation systems, and can be either electronically or manually controlled. In a system incorporating the control valve, the fertilizing can be electronically programmed in accordance with a desired schedule in advance.

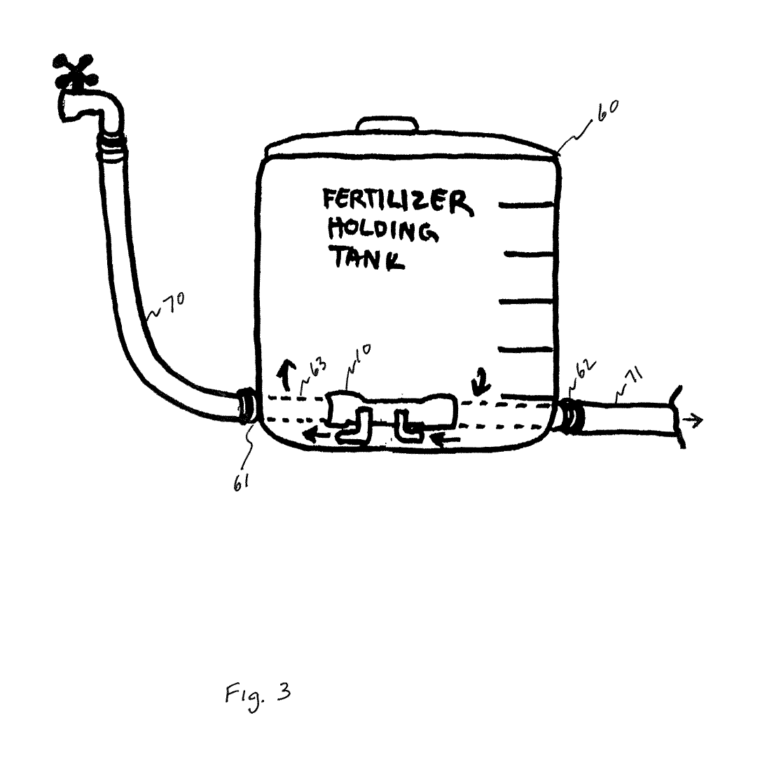

In another example of the invention, the tee valve is incorporated into the feeder canister. As shown in FIG. 3, this example is particularly well-suited for a residential garden hose application, but the sizes and configurations of the tubes, hoses, and connectors can be adjusted to adapt it to other settings. The feeder canister 60 includes a first connector 61 configured to mate with a female end of a typical garden hose 70 and a second connector 62 configured to mate with a male end of a garden hose 71. In this configuration, water would be expected to travel into the feeder canister at the first connector and exit the canister at the second connector.

Inside the feeder canister, a tube 63 connects the first connector to the second connector, creating a fluid flow path from the first connector to the second connector. A tee valve 10 in accordance with the above description is provided in the fluid flow path, preferably in a form that is integrally formed at a central location of the tube connecting the first and second connectors. Water traveling into the tube follows a primary flow path through the tube and the tee valve, as described above. A secondary flow path travels out the first extension tube of the tee valve where it mixes with the contents of the canister and returns to the tee valve through the second extension tube. The primary water flow now includes fertilizer (or other contents from the canister) as it exits the second connector.

In a preferred form, the canister is connected to a hose at the second connector, with the hose 71 being connected to a sprinkler at its terminal end. Thus, in the same fashion as described above for a fixed irrigation system (not shown), the canister having an incorporated tee valve can be used to facilitate fertilization using residential garden hoses and sprinklers.

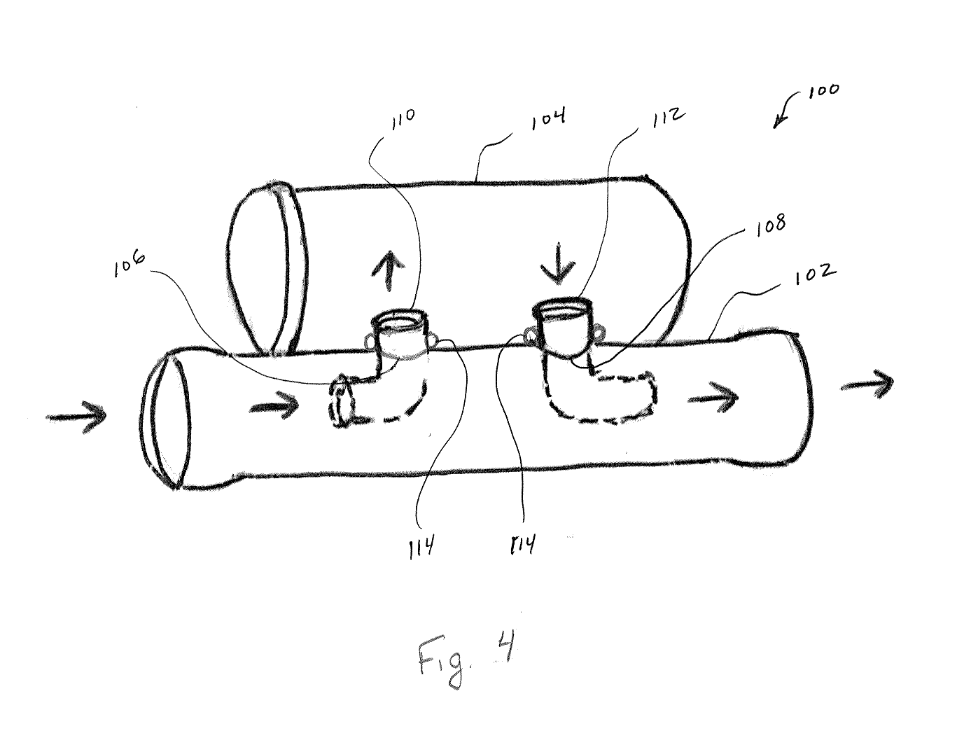

FIG. 4 shows another example of a tee valve system 100 in which a tee valve 102 is directly coupled to a feeder canister 104. This example is advantageously well-suited for quickly removing and replacing feed canisters 102 without having to disconnect portions of the tee valve system and without the need for intermediate hose connectors, such as the ones described above. The feeder canister 104 includes openings 106, 108 to receive respective tee valve tubes 110, 112. In one embodiment, the feeder canister 104 includes compressible seals 114 adjacent the openings 106, 108. The compressible seals 114 operate to reduce or eliminate fluid leakage between the canister 104 and the tee valve tubes 110, 112. In a preferred embodiment, the seals 114 are compressible O-ring seals.

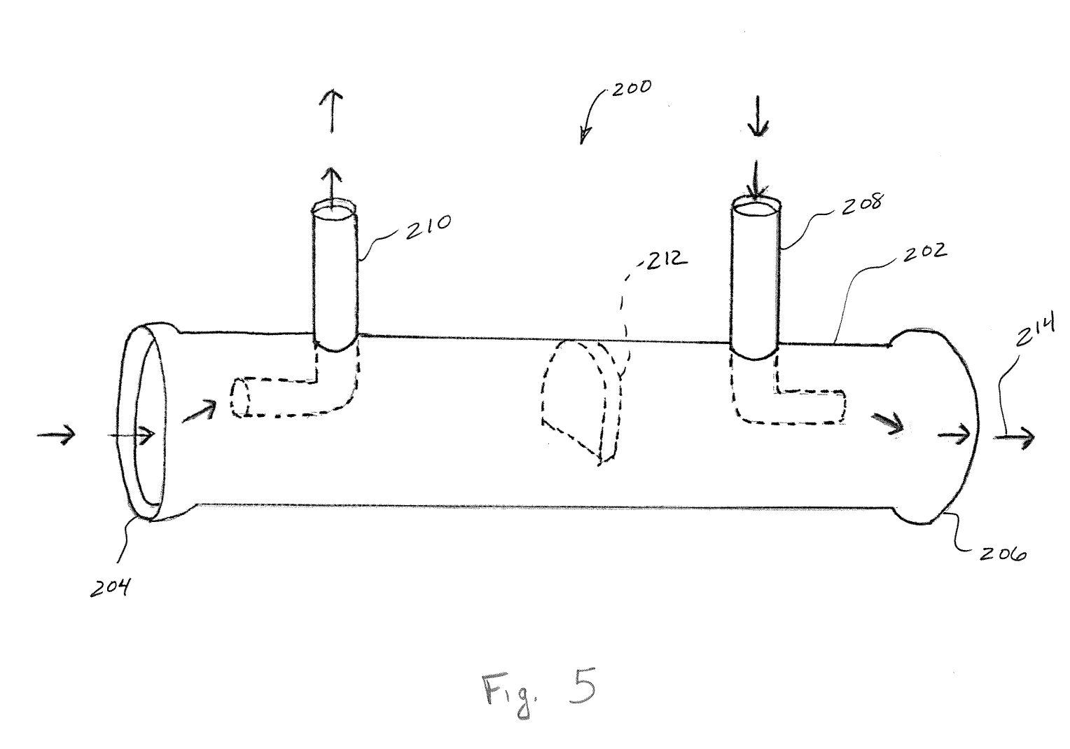

FIG. 5 shows another example of a tee valve 200 having a primary water conduit 202, a first end 204 for receiving water flow and a second end 206 through which water exits. In addition, the tee valve 200 includes inlet and outlet tube assemblies 208, 210. The difference between the tee valve 200, as illustrated, and the tee valve 10 of FIG. 1 is that the tee valve 200 includes a flow deflector 212. The flow deflector 212 operates to reduce the internal flow area of the tee valve 200, which in turn may increase the water pressure upstream of the deflector 212 while decreasing the water pressure downstream of the deflector 212. The flow deflector 212 may take many different shapes and sizes. In addition, the flow deflector 212 may be moveable within the tee valve 200 such that the upstream and downstream pressures in the tee valve 200 and thus the exiting flow rate 214 is adjustable. In another embodiment, the flow deflector 212 may take the form of an automatically or manually adjustable device configured to generate a venture effect within the tee valve 200. Preferably, the venturi effect would be generated within the tee valve 200 between the tube assemblies 208, 210.

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A fluid conduit, comprising:
a main fluid conduit having a first end for receiving a fluid, a second end through which the fluid may exit, and a central passage between the first end and second end;
an outflow tube extending into the main fluid conduit, the outflow tube being configured to receive a first portion of the fluid within the main fluid conduit and to direct the first portion of fluid to a location external to the main fluid conduit; and
an inflow tube extending into the main fluid conduit, the inflow tube being in fluid communication with the main fluid conduit and configured to direct a second fluid into the main fluid conduit from a location external to the main fluid conduit.

2. The fluid conduit of claim 1, wherein the outflow tube is in fluid communication with the inflow tube.

3. The fluid conduit of claim 1, further comprising a first extension conduit in fluid communication with the outflow tube, an additive reservoir in fluid communication with the first extension tube, and a second extension tube in fluid communication with the additive reservoir, whereby the first portion of fluid travels in a direction from the first extension tube, through the additive reservoir, and into the second extension tube.

4. The fluid conduit of claim 3, wherein additive reservoir contains a fertilizer.

5. The fluid conduit of claim 4, further comprising an irrigation conduit in fluid communication with the second end of the main fluid conduit, the irrigation conduit further having at least one sprinkler in fluid communication with the irrigation conduit to deliver the fluid to the sprinkler.

6. The fluid conduit of claim 5, wherein irrigation is at least partially buried underground to form an underground sprinkler system.

7. The fluid conduit of claim 5, wherein the additive reservoir is at least partially buried underground.

8. The fluid conduit of claim 5, further comprising a valve for selectively controlling fluid travel through the outflow tube.

9. The fluid conduit of claim 1, wherein main fluid conduit comprises a first central axis and the outflow tube comprises a second central axis, the first central axis being substantially parallel to the second central axis.

10. The fluid conduit of claim 1, wherein fluid comprises a direction of flow through the central passage and the outflow tube comprises an orifice that faces in the direction of flow.

11. The fluid conduit of claim 1, further comprising a canister having an interior, the fluid conduit being housed substantially within the interior of the canister.

12. The fluid conduit of claim 11, wherein the first end of the fluid conduit is in fluid communication with a first orifice formed on the canister and the second end of the fluid conduit is in fluid communication with a second orifice formed on the canister.

13. The fluid conduit of claim 13, wherein the canister contains a fertilizer.

14. The fluid conduit of claim 13, further comprising a water source and a first hose in fluid communication with the water source and the first orifice, and a second hose in fluid communication with the second orifice, whereby water provided by the water source will travel through the first hose, into the fluid conduit, and exit the fluid conduit into the second hose.

15. A fluid conduit, comprising:
a main fluid conduit having a first end for receiving a fluid, a second end through which the fluid may exit, and a central passage between the first end and second end;
an outflow tube extending into the main fluid conduit, the outflow tube being configured to receive a first portion of the fluid within the main fluid conduit and to direct the first portion of fluid to a location external to the main fluid conduit;
a first extension tube in fluid communication with the outflow tube;
an inflow tube extending into the main fluid conduit, the inflow tube being in fluid communication with the main fluid conduit and configured to direct a second fluid into the main fluid conduit from a location external to the main fluid conduit; and
a second extension tube in fluid communication with the inflow tube.

16. The fluid conduit of claim 15, wherein main fluid conduit comprises a first central axis and the outflow tube comprises a second central axis, the first central axis being substantially parallel to the second central axis.

17. The fluid conduit of claim 15, wherein fluid comprises a direction of flow through the central passage and the outflow tube comprises an orifice that faces in the direction of flow.
